(19) United States
(12) Patent Application Publication
(10) Pub. No.: US 2017/0118269 A1
(43) Pub. Date: Apr. 27, 2017

(54) DYNAMIC ADJUSTMENT OF CONNECTION SETTINGS BASED ON PER-UE SYSTEM STATUS AND USAGE INFORMATION

(71) Applicant: QUALCOMM Incorporated, San Diego, CA (US)

(72) Inventors: Hee Jun Park, San Diego, CA (US); Krishna Sekar, La Jolla, CA (US)

(21) Appl. No.: 14/919,482

(22) Filed: Oct. 21, 2015

(51) Int. Cl. H04L 29/08; H04L 29/06

(52) U.S. Cl. CPC H04L 67/06; H04L 69/16

(57) ABSTRACT

Methods, systems, and devices for wireless communication are described. A software application executing on a user equipment (UE) identifies an indication of status information of the UE; the status information is transmitted from the UE to a remote server; the UE receives, by way of a base station associated with the UE, a recommended connection setting for the UE based at least in part on the indication of status information, the recommended connection setting determined by the remote server.

### BACKGROUND

The following relates generally to wireless communication, and more specifically to dynamic adjustment of connection settings based on per-user equipment (UE) system status and usage information.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may be otherwise known as a UE.

In some wireless communication networks, there may be a plurality of connection settings establishing certain parameters for a wireless connection. For example, each service provider may develop a policy and a set of static, UE-agnostic parameters and settings for each base station. The parameters and settings may include choices and utilization of carrier aggregation levels, frequency bands, downlink and uplink data rates, and/or connected mode discontinuous reception (CDRx) timer settings, etc. The connection settings may impact the power consumption of the UE, as well as a the performance (e.g., response latency, data rate) of the UE. In real usage scenarios, a UE's individual power consumption and performance varies depending on the dynamic behavior of usage patterns and hardware/software design differences of each UE. However, as explained above, current connection settings that impact a UE's power consumption and performance are static.

### SUMMARY

A wireless communication system may identify status information related to a user equipment (UE). In some embodiments, the status information may be system status and/or usage information of the UE. Using an existing standard communication protocol (e.g., a transmission control protocol/internet protocol (TCP/IP) connection), the status information is transmitted to a network server via a base station. Although communications between the UE and the network server are enabled by a base station, the base station does not process or consider the status information being transmitted between the UE and the network server at this time. The network server receives status information from multiple UEs and runs at least one algorithm on the information to determine recommended connection settings for each individual UE. The recommended connection settings are transmitted from the network server to the corresponding base station for each UE by way of an existing standard communication protocol. Based on the recommended connection settings, the base station adjusts the connection setting for each UE connection. In some embodiments, the adjustment is made with consideration of available network resources.

A method of wireless communication is described. The method may include identifying an indication of status information of a UE, transmitting the indication of status information from the UE to a network server and receiving, from a base station associated with the UE, a recommended connection setting for the UE based at least in part on the indication of status information, the recommended connection setting determined by the network server.

An apparatus for wireless communication is described. The apparatus may include means for identifying an indication of status information of a UE, means for transmitting the indication of status information from the UE to a network server and means for receiving, from a base station associated with the UE, a recommended connection setting for the UE based at least in part on the indication of status information, the recommended connection setting determined by the network server.

A further apparatus is described. The apparatus may include a processor, memory in electronic communication with the processor, and instructions stored in the memory. The instructions may be operable to cause the processor to identify an indication of status information of a UE, transmit the indication of status information from the UE to a network server and receive, from a base station associated with the UE, a recommended connection setting for the UE based at least in part on the indication of status information, the recommended connection setting determined by the network server.

A non-transitory computer readable medium for wireless communication is described. The non-transitory computer-readable medium may include instructions to cause a processor to identify an indication of status information of a UE, transmit the indication of status information from the UE to a network server and receive, from a base station associated with the UE, a recommended connection setting for the UE based on the indication of status information, the recommended connection setting determined by the network server.

In some examples of the method, apparatus, or non-transitory computer-readable medium described above, the indication of status information is system status and usage information of the UE.

Some examples of the method, apparatus, or non-transitory computer-readable medium described above may further include processes, features, means, or instructions for transmitting the indication of status information when a system status of the UE satisfies a predetermined threshold.

Some examples of the method, apparatus, or non-transitory computer-readable medium described above may further include processes, features, means, or instructions for transmitting the indication of status information at predetermined time intervals.

Some examples of the method, apparatus, or non-transitory computer-readable medium described above may further include processes, features, means, or instructions for transmitting the indication of status information using a transmission control protocol/internet protocol (TCP/IP) connection.

In some examples of the method, apparatus, or non-transitory computer-readable medium described above, the indication of status information is identified based at least in part by a software application executing on the UE.

Some examples of the method, apparatus, or non-transitory computer-readable medium described above may further include processes, features, means, or instructions for receiving from the base station an adjusted connection setting based on the recommended connection setting.

In some examples of the method, apparatus, or non-transitory computer-readable medium described above, the adjusted connection setting is based on available network resources. In some examples of the method, apparatus, or non-transitory computer-readable medium described above, the adjusted connection setting is based on power and performance tradeoff parameters.

In some examples of the method, apparatus, or non-transitory computer-readable medium described above, the adjusted connection setting is based on a prioritization of available network resources. In some examples of the method, apparatus, or non-transitory computer-readable medium described above, the recommended connection setting is based on one or more parameters associated with the UE.

A method of wireless communication is described. The method may include receiving, from a first UE, an indication of first status information for the first UE, determining a recommended connection setting for the first UE based at least in part on the first status information, transmitting the determined recommended connection setting to a first base station associated with the first UE and applying the determined recommended connection setting to the first base station.

An apparatus for wireless communication is described. The apparatus may include means for receiving, from a first UE, an indication of first status information for the first UE, means for determining a recommended connection setting for the first UE based at least in part on the first status information, means for transmitting the determined recommended connection setting to a first base station associated with the first UE and means for applying the determined recommended connection setting to the first base station.

A further apparatus is described. The apparatus may include a processor, memory in electronic communication with the processor, and instructions stored in the memory. The instructions may be operable to cause the processor to receive, from a first UE, an indication of first status information for the first UE, determine a recommended connection setting for the first UE based at least in part on the first status information, transmit the determined recommended connection setting to a first base station associated with the first UE and apply the determined recommended connection setting to the first base station.

A non-transitory computer readable medium for wireless communication is described. The non-transitory computer-readable medium may include instructions to cause a processor to receive, from a first UE, an indication of first status information for the first UE, determine a recommended connection setting for the first UE based on the first status information, transmit the determined recommended connection setting to a first base station associated with the first UE and apply the determined recommended connection setting to the first base station.

Some examples of the method, apparatus, or non-transitory computer-readable medium described above may further include processes, features, means, or instructions for receiving, from a second UE, an indication of second status information for the second UE; determining a second recommended connection setting based on the second status information; transmitting the second recommended connection setting to a second base station associated with a third UE; and applying the second recommended connection setting to the second base station.

Some examples of the method, apparatus, or non-transitory computer-readable medium described above may further include processes, features, means, or instructions for determining the recommended connection setting based on one or more parameters associated with the UE.

Some examples of the method, apparatus, or non-transitory computer-readable medium described above may further include processes, features, means, or instructions for receiving the indication of first status information using a transmission control protocol/internet protocol (TCP/IP) connection.

### BRIEF DESCRIPTION OF THE DRAWINGS

FIG. 1 shows an example of a wireless communications system that supports dynamic adjustment of connection settings based on per-user equipment (UE) system information in accordance with aspects of the present disclosure;

FIGS. 2A and 2B show examples of a wireless communications system that supports dynamic adjustment of connection settings based on per-user equipment (UE) system information in accordance with aspects of the present disclosure;

FIG. 3 shows an example of a process flow in a system that supports dynamic adjustment of connection settings based on per-user equipment (UE) system information in accordance with aspects of the present disclosure;

FIGS. 4 through 8 show block diagrams of a wireless device that supports dynamic adjustment of connection settings based on per-user equipment (UE) system information in accordance with aspects of the present disclosure;

FIG. 9 shows a block diagram of a system including a UE that supports dynamic adjustment of connection settings based on per-user equipment (UE) system information in accordance with aspects of the present disclosure; and

FIGS. 10 through 13 show methods for dynamic adjustment of connection settings based on per-user equipment (UE) system information in accordance with aspects of the present disclosure.

### DETAILED DESCRIPTION

In some wireless communication networks, connection settings may establish certain parameters for a wireless connection between a user equipment (UE) and a base station. These parameters may impact the power consumption of the UE operating on the network. Connection parameters may include carrier aggregation levels, frequency bands, downlink/uplink data rates and/or Connected Mode Discontinuous Reception (CDRx) timer settings, etc.

In some cases, service providers may develop a static, UE-agnostic policy for establishing connection settings. These policies may be applied to all base stations and the UEs. In real usage scenarios, the connection settings affect a UE's power consumption and performance (e.g., response latency and data rate) with varying degrees. For example, the power consumption and performance may vary significantly depending on the dynamic behavior of usage patterns, location, hardware and software design differences, and/or power performance preferences on the UE side.

Some wireless systems do not allow a base station to receive power usage status information and optimize the parameter settings for individual UEs. However, according to the present disclosure, some wireless systems may utilize dynamic connection settings to improve power usage and performance. In some embodiments, a base station may vary connection setting values for each individual UE based on status and usage information of the individual UE.

In one example of dynamic connection setting, software executing on the UE may read the UE system status and usage information (hereinafter “status information”) and send the information to the network server (e.g., a server provider or third-party vendor providing per-UE power consumption and usage analysis). In one embodiment, the status information may include power status information and other parameters associated with the UE. The UE system status information may then be transferred by way of an existing standard communication protocol. In one embodiment, the status information may be transmitted by way of a transmission control protocol/internet protocol (TCP/IP) connection. The base station associated with the UE enables transmission of the status information, but at this stage the associated base station does not process the transmitted information. In some cases, the UE system status information may bypass the base station; the base station may not process or take any data at this stage.

The network server may run an algorithm based on the received information and determine recommended connections settings for the UE. In one embodiment, the network server sends the specific UE-recommended connection settings to the associated base station. The base station may adjust the connection settings for the individual UE based on the recommended connection settings and available network resources. In some embodiments, there may be conflicts among neighboring UEs. In such cases, the base station may prioritize the resources when adjusting the connection settings for each UE.

In another embodiment, a UE may move from an initial cell covered by a base station to another cell covered by a new base station. In this embodiment, the initial base station may transfer the adjusted connection settings to the new base station. In yet another embodiment, not all UEs within the network may be enabled to participate in receiving individualized connection settings. For example, participating UEs may be UEs executing a specific system status software application; in contrast, non-participating UEs may not execute the system status software application. When some UEs are not participating, default connection settings may be used to adjust the settings for non-participating UEs. More specifically, aggregated data collected from UEs enabled to participate in receiving individualized connection settings may be used to optimize the default connection settings (e.g., the network may apply the median settings from participating UEs to non-participating UEs).

Aspects of the disclosure are initially described in the context of an example wireless communication system, and are further illustrated by and described with reference to apparatus diagrams, system diagrams, and flowcharts that relate to dynamic adjustment of connection settings based on per-UE system status and usage information.

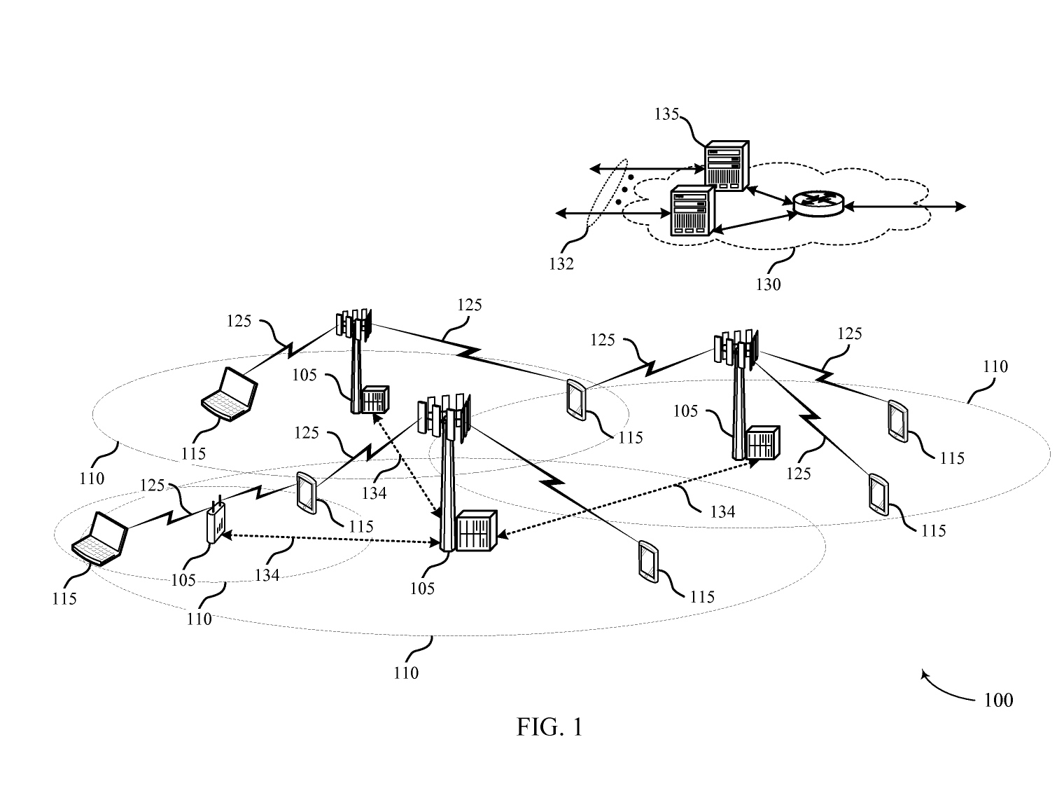

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network. Wireless communications system 100 may support dynamic and individualized connection settings for each UE within the network, thus improving power consumption and usage.

Base stations 105 may wirelessly communicate with UEs 115 via one or more base station antennas. Each base station 105 may provide communication coverage for a respective geographic coverage area or network 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, an machine type communication (MTC) device or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller. In some examples, base stations 105 may be macro cells, small cells, hot spots, or the like. Base stations 105 may also be referred to as evolved Node Bs (eNodeBs or eNBs) 105.

A base station 105 may be connected by an S1 interface to a network server 135 of a core network 130. The core network may be an evolved packet core (EPC), which may include at least one mobility management entity (MME), at least one serving gateway (S-GW), and at least one PDN gateway (P-GW). The MME may be the control node that processes the signaling between the UE 115 and the EPC. All user internet protocol (IP) packets may be transferred through the S-GW, where the S-GW may be connected to the P-GW. The P-GW may provide IP address allocation as well as other functions. The P-GW may be connected to the network operators IP services. The operators IP services may include the Internet, the Intranet, an IP Multimedia Subsystem (IMS), and a Packet-Switched (PS) Streaming Service (PSS).

In some cases, a wireless communications system may utilize one or more enhanced component carriers (ECCs). An ECC may be characterized by one or more features including: flexible bandwidth, variable length TTIs, and/or modified control channel configuration. In some cases, an ECC may be associated with a carrier aggregation configuration or a dual connectivity configuration (i.e., when multiple serving cells have a suboptimal backhaul link). An ECC may also be configured for use in unlicensed spectrum or shared spectrum (where more than one operator is licensed to use the spectrum). An ECC characterized by flexible bandwidth may include one or more segments that may be utilized by UEs 115 that do are not capable of monitoring the whole bandwidth or prefer to use a limited bandwidth (e.g., to conserve power).

In some cases, an ECC may utilize a variable TTI length, which may include use of a reduced or variable symbol duration. In some cases the symbol duration may remain the same, but each symbol may represent a distinct TTI. In some cases an ECC may include multiple hierarchical layers associated with the different TTI lengths. For example, TTIs at one hierarchical layer may correspond to uniform 1 millisecond (ms) subframes, whereas in a second layer, variable length TTIs may correspond to bursts of short duration symbol periods. In some cases, a shorter symbol duration may also be associated with increased subcarrier spacing.

Flexible bandwidth and variable TTIs may be associated with a modified control channel configuration (e.g., an ECC may utilize an enhanced physical downlink control channel (ePDCCH) for DL control information). For example, one or more control channels of an ECC may utilize frequency-division multiplexing (FDM) scheduling to accommodate flexible bandwidth use. Other control channel modifications include the use of additional control channels (e.g., for evolved multimedia broadcast service (eMBMS) scheduling, or to indicate the length of variable length UL and DL bursts), or control channels transmitted at different intervals. An ECC may also include modified or additional hybrid automatic repeat request (HARD) related control information.

In one embodiment, UE 115 may transmit status information to the network server 135 by way of communications with base station 105. Network server 135 may run algorithms to analyze the received status information in order to determine a recommended connection setting individualized for UE 115. The network server 135 then sends the recommended connection setting to the base station 105, where the base station 105 then adjusts the connection settings for the UE 115.

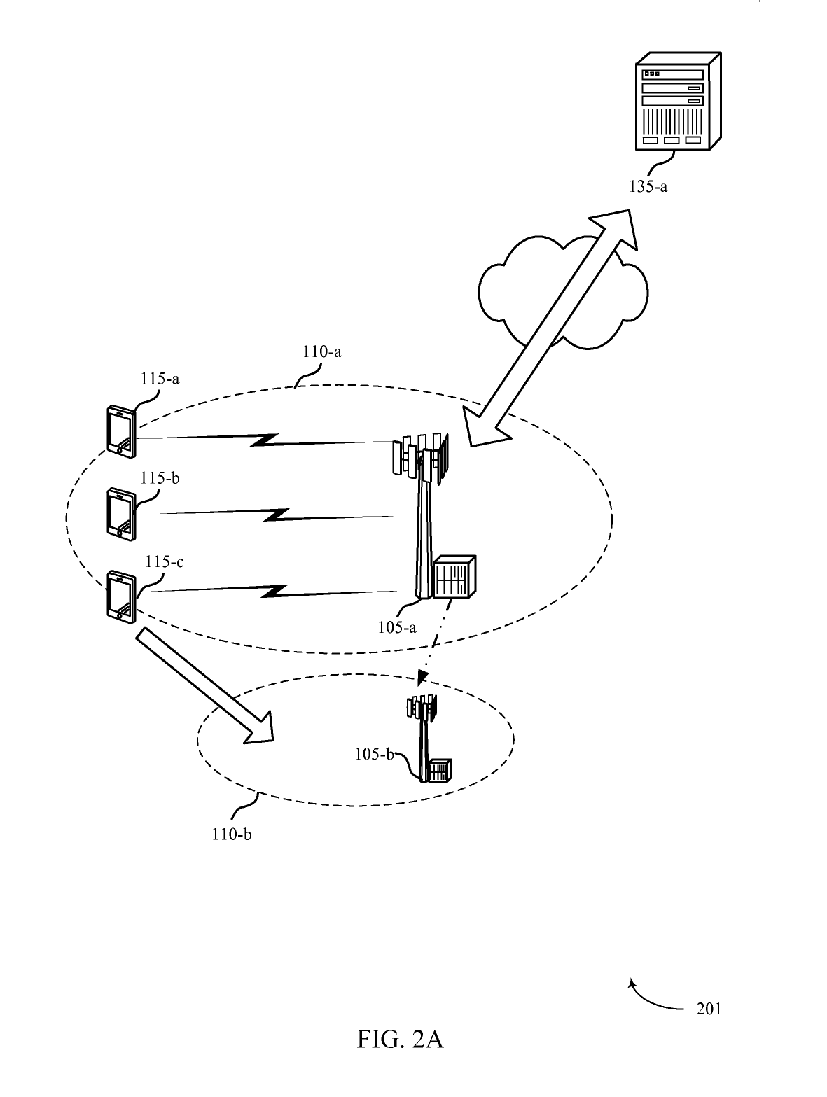

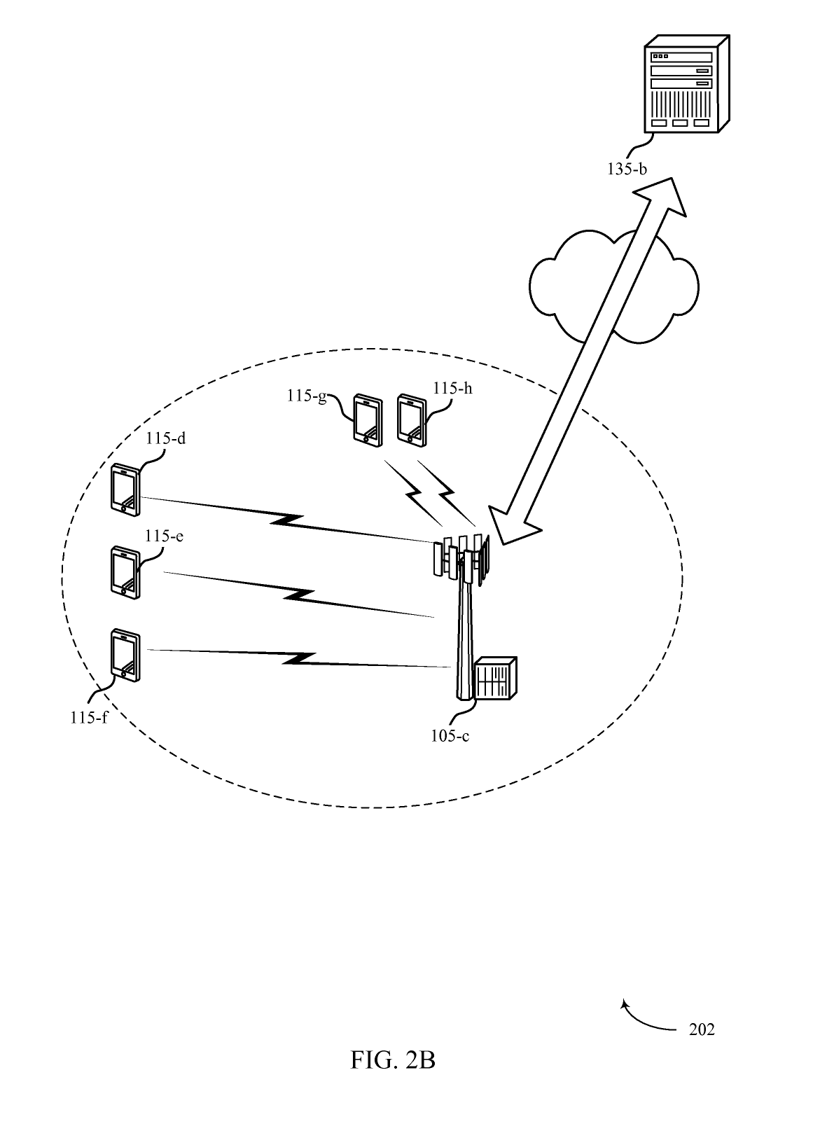

FIGS. 2A and 2B illustrate examples of wireless communications systems 201 and 202 that support dynamic adjustment of connection settings based on per-UE system status and usage information. Wireless communications systems 201 may include base stations 105-a and 105-b and UEs 115-a, 115-b, and 115-c, which may be examples of the corresponding devices described with reference to FIG. 1. In one embodiment, referring to FIG. 2A, wireless communications system 201 may represent a situation in which a plurality of UEs receive individualized connection settings from a corresponding base station. In addition, wireless communications system 201 may further describe a situation in which one UE (e.g., UE 115-c) receives individualized connection settings while connected within a first network 110-a and then moves to a second network 110-b. In this embodiment, a first base station 105-a transfers the current connection settings for UE 115-c to a second base station 105-b.

Referring to FIG. 2B, wireless communications system 202 may represent a situation in which individual connection settings are determined for participating-UEs 115-d, 115-e, and 115-f, and from the individual connection settings a set of default connection settings are transmitted to non-participating UEs 115-g and 115-h. Adjusting the connection settings, and thus the operating parameters of a UE, is described in more detail below.

In both wireless communications systems 201 and 202, connection settings transmitted from a base station 105 to a UE 115 may establish certain parameters for the wireless connection. Thus, the parameters which result at least in part from the received connection settings may affect the performance and power consumption of the UE 115 operating on the network.

In some embodiments, service providers may develop a static, UE-agnostic policy for setting parameters which may be equally applied to all base stations and UEs under control of the service provider. For example, in FIG. 2A, static connection settings may be applied to base station 105-a and UEs 115-a, 115-b, and 115-c, regardless of any differences between the devices. In real usage scenarios, however, the application of connection settings on the power consumption and performance of a UE may vary based on, at least in part, the specific model of a UE, hardware and software differences, the dynamic behavior of individual UE usage patterns (e.g., time and location of use), and/or and power and performance preferences for a UE 115.

The connection parameters which may affect the power consumption and performance of a UE may include, but are not limited to, carrier aggregation levels, frequency bands, DL/UL data rates, Connected Mode Discontinuous Reception (CDRx) timer settings, etc.

In FIG. 2A, wireless communications system 201 enables dynamic connection settings on a per-UE basis to improve power consumption and performance. That is, a base station 105 may vary its connection setting values based on a plurality of information related to a UE 115. In one embodiment, software executing on a UE 115-a, 115-b, and/or 115-c may identify status information related to power consumption and performance. For example, the status information identified by the software application may include: the current type of power source (e.g., internal battery or external power source); remaining battery percentage; whether the display is on or off; the percentage of residency and duration profile of DL/UL active time in previous time periods; percentage of residency and duration profile of carrier aggregation (SCell) active time in previous time periods; an indication of energy efficiency of DL/UL (Mbps/mW); UE system temperature and/or a UE's manual settings (e.g., battery saving mode or high performance mode).

The UE 115 may send the identified status information to a network server 135-a by way of a standard communication protocol (e.g. general internet communication layers and protocol such as TCP/IP, user datagram protocol (UDP), and/or protocols at higher levels than media access control (MAC) layer protocols). The network server 135-a may be an example of the network server 135 described in FIG. 1. In one embodiment, status information may be sent if the status information satisfies a pre-determined threshold. For example, the status information may represent an operating temperature of the UE. If the operating temperature exceeds, for example, 80 degrees Fahrenheit (F), the status information may be sent to the network server 135 in order to adjust the connection settings.

In another embodiment, status information may be sent at pre-determined time intervals regardless if the status information has satisfied a threshold. Although the base station 105-a may enable communications between the UE 115 and the network server 135-a, the base station 105-a may not process or take in any data at this stage.

Upon receiving the status information from the UE 115, network server 135-a analyzes the received status information to determine recommended connection settings for UE 115. In one embodiment the network server 135-a analyzes the information by way of running an algorithm. The recommended connection settings are then sent from the network server 135-a to the base station 105-a, again using a standard communication protocol.

The base station 105-a receives the recommended connection settings and adjusts the recommended connection settings on a per-UE basis. In one example, UE 115 may have switched from streaming video to web browsing. In this scenario, the dynamic application of connection settings applied from the base station 105-a may involve minimizing SCell active time. In another example, the specific model of UE 115 may have high PDCCH duration (data idle). Thus, the base station 105-a may adjust the connection settings to minimize PDCCH duration and tune the CDRx timers to be shorter. In yet another example, the UE 115 may have low battery power, resulting in dynamic connection settings which disable high data rate features and allocates power-friendly resources (e.g. single carrier only, low power frequency band, energy efficient data rate, low power timer settings, and/or shorter deactivation time settings for SCell). In another example, the UE may be connected to an AC adapter, and may receive high performance oriented connection settings.

The adjustment of connection settings may be at least partially based on available network resources. In addition, if there are conflicts among UEs that may benefit from low power settings, the network resources may be prioritized.

Referring still to FIG. 2A, UE 115-c is connected to network 110-a and has received adjusted connection settings from base station 105-a. In one embodiment, UE 115-c moves from network 110-a to network 110-b, where network 110-b is covered by base station 105-b. In this embodiment, base station 105-a may transfer the current adjusted connection settings to the new base station 105-b.

FIG. 2B illustrates wireless communications system 202. Base station 105-c may communicate with UEs 115-d, 115-e, and 115-f, and these devices may be synonymous with base station 105-a and UEs 115-a, 115-b, and 115-c described with reference to FIG. 2A. Similarly, base station 105-c may adjust connection settings the connection settings for the UEs 115-d, 115-e, and 115-f in a fashion similar to that described with reference to FIG. 2A. In addition, wireless communications system 202 comprises UEs 115-g and 115-h. In one embodiment, UEs 115-g and 115-h are “non-participating” UEs; thus, these UEs are not enabled to send status information to network server 135-b (e.g., the “non-participating” UEs may not have the status information software application).

In this embodiment, default connection settings may be used for UEs 115-g and 115-h. More specifically, status information received at the network server 135-b from participating UEs 115-d, 115-e, and 115-f may be aggregated to determine default connection settings for the non-participating UEs. In some embodiments, the default connection settings for the non-participating UEs may be gradually adjusted and updated based on the status information sent to the network server 135-b from the participating UEs over time.

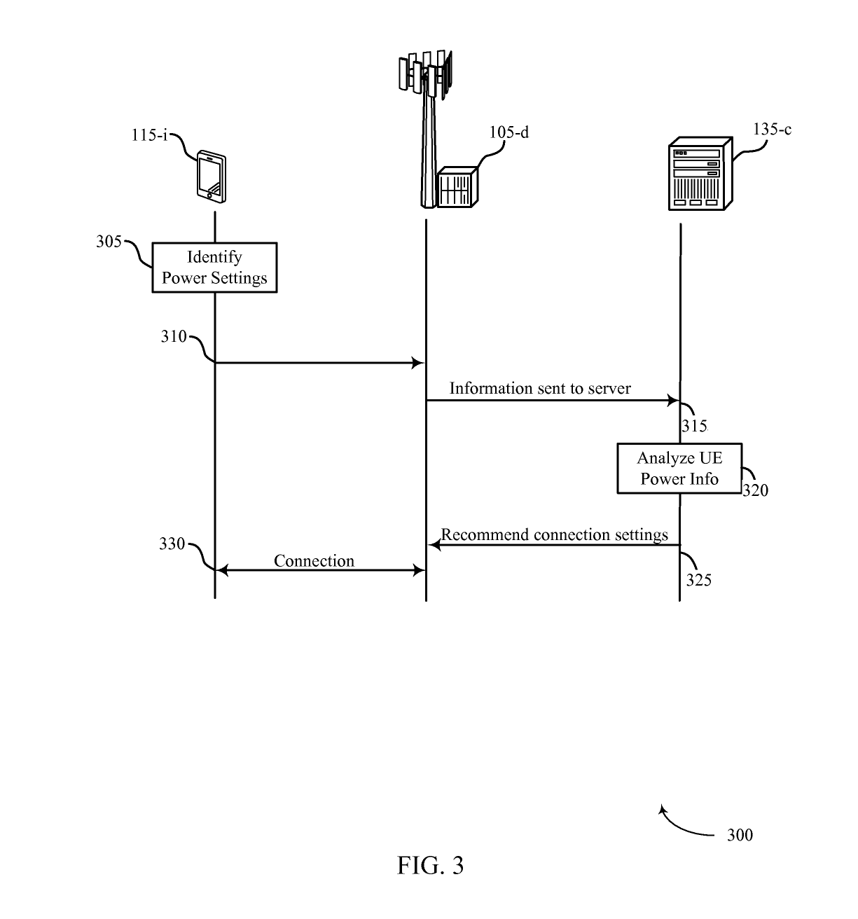

FIG. 3 illustrates an example of a process flow 300 for dynamic adjustment of connection settings based on per-UE system status and usage information in accordance with various aspects of the present disclosure. Process flow 300 may include UE 115-i and base station 105-d, which may be examples of the corresponding devices described with reference to FIGS. 1, 2A, and/or 2B.

At step 305, UE 115-i may execute a software application on the UE to determine the status information. In one example, UE 115-i may identify an indication of status information.

At steps 310 and 315, the status information related to UE 115-i may be sent to network server 135-c through base station 105-d. For example, UE 115-i may transmit the indication of status information from UE 115-i to the network server 135-c. In some embodiments, the status information may be transmitted from UE 115-i to the network server 135-c if the status information satisfies a pre-determined threshold; for example, if the percentage of battery power remaining is below 15%. In another embodiment, the status information may be transmitted from UE 115-i to the network server 135-c at pre-determined time intervals. Regardless of when the information is transmitted, transmissions from UE 115-i to the network server 135-c may be by way of a plurality of communication standards including, but not limited to, general internet communication layers and protocol such as TCP, user datagram protocol (UDP), and/or protocols at higher levels than media access control (MAC) layer protocols.

At step 320, the network server 135-c may analyze the system status information received from UE 115-i. In one embodiment, the analysis may be enabled by algorithms running on the network server 135-c to determine recommended connection settings for UE 115-i.

At step 325, the network server 135-c may pass on recommended connection settings to base station 105-d. For example, the network server 135-c transmits the determined recommended connection settings to base station 105-d associated with UE 115-i.

At step 330, base station 105-d may adjust the connection settings for UE 115-i based on the recommended connection settings received from the network server 135-c. In some embodiments, the base station 105-d adjusts the connection settings for UE 115-i based on a combination of the received recommended connection settings and the available network resources. If there are conflicts between multiple UEs in the network, the base station 105-d may prioritize the network resources when adjusting the connection settings.

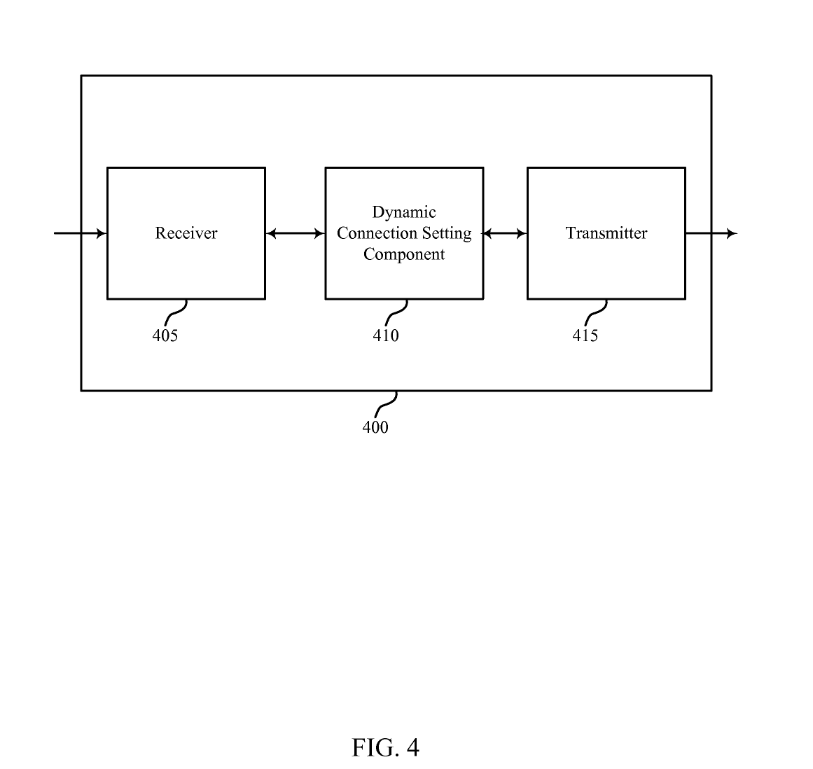

FIG. 4 shows a block diagram of a wireless device 400 that supports dynamic adjustment of connection settings based on per-UE system status and usage information in accordance with various aspects of the present disclosure. In one embodiment, wireless device 400 may be an example of aspects of a UE 115 described with reference to FIGS. 1, 2A, 2B, and/or 3. In another embodiment, wireless device 400 may be an example of a base station 105 and/or a network server 135 described with reference to FIGS. 1, 2A, 2B, and/or 3. In one embodiment, wireless device 400 may include a receiver 405, a dynamic connection setting component 410, and a transmitter 415. Wireless device 400 may also include a processor. Each of these components may be in communication with each other.

The receiver 405 may receive information such as packets, user data, or control information associated with various information channels (e.g., control channels, data channels, and information related to dynamic adjustment of connection settings based on per-UE system status and usage information, etc.). Information may be passed on to other components of the device.

In one embodiment, the dynamic connection setting component 410 may identify an indication of status information of a UE. The dynamic connection setting component may transmit the indication of status information from the UE to a network server, and receive, from a base station associated with the UE, a recommended connection setting for the user equipment. The recommended connection setting may be determined by the network server and may be based at least in part on the indication of status information.

In another embodiment, the dynamic connection setting component 410 may receive, from the UE, an indication of first status. The dynamic connection setting component 410 may determine a recommended connection setting for the UE based at least in part on the first status information, and then transmit the recommended connection setting to a base station associated with the UE.

The transmitter 415 may transmit signals received from other components of wireless device 400. The transmitter 415 may be collocated with a receiver in a transceiver component. The transmitter 415 may include a single antenna or a plurality of antennas.

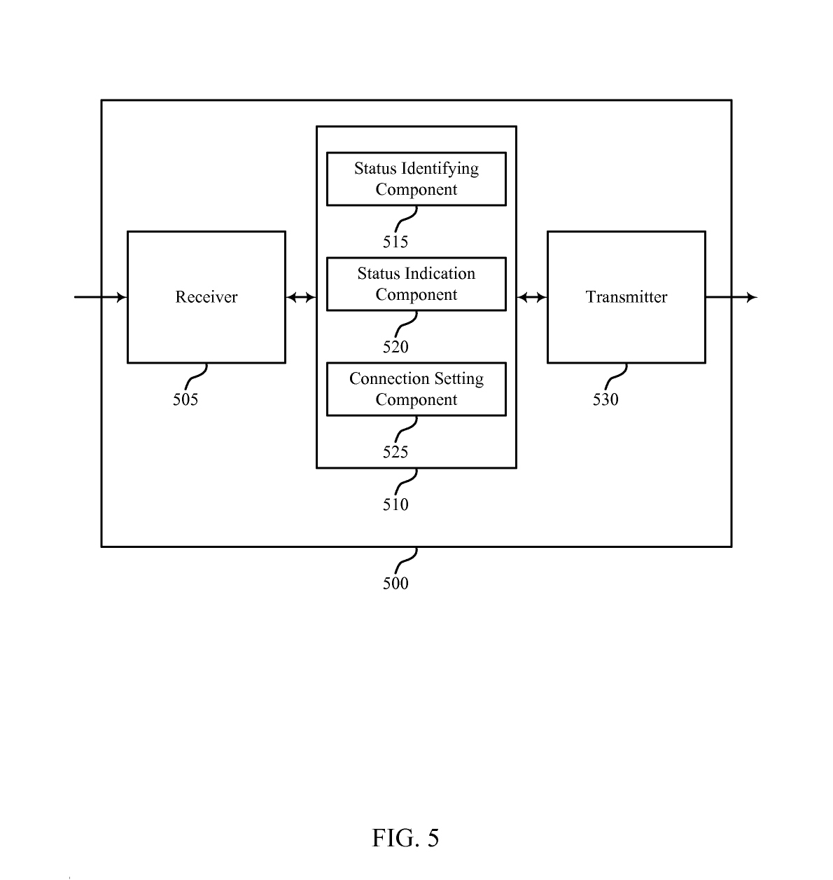

FIG. 5 shows a block diagram of a wireless device 500 that supports dynamic adjustment of connection settings based on per-UE system status and usage information in accordance with various aspects of the present disclosure. Wireless device 500 may be an example of aspects of a wireless device 400 or a UE 115 described with reference to FIGS. 1, 2A, 2B, 3 and/or 4. Wireless device 500 may include a receiver 505, a dynamic connection setting component 510, and a transmitter 530. Wireless device 500 may also include a processor. Each of these components may be in communication with each other.

The receiver 505 may receive information which may be passed on to other components of the device. The receiver 505 may also perform the functions described with reference to the receiver 405 of FIG. 4.

The dynamic connection setting component 510 may be an example of aspects of dynamic connection setting component 410 described with reference to FIG. 4. In one embodiment, the dynamic connection setting component 510 may include a status identifying component 515, a status indication component 520, and a connection setting component 525.

In one embodiment, the status identifying component 515 may identify an indication of status information of a UE. In some cases, the indication of status information is identified based at least in part by a software application executing on the user equipment.

In one embodiment, the status indication component 520 may transmit the indication of status information from the UE to a network server when the status information satisfies a predetermined threshold. In another embodiment, the status indication component 520 may transmit the indication of status information at predetermined time intervals.

The connection setting component 525 may receive, from a base station associated with the UE, a recommended connection setting for the UE based on the indication of status information. In one example, the recommended connection setting may be determined by the network server 135. In some embodiments, the recommended connection setting may be based on one or more parameters associated with the UE.

The transmitter 530 may transmit signals received from other components of wireless device 500. In some embodiments, the transmitter 530 may be collocated with a receiver in a transceiver component. The transmitter 530 may utilize a single antenna or a plurality of antennas.

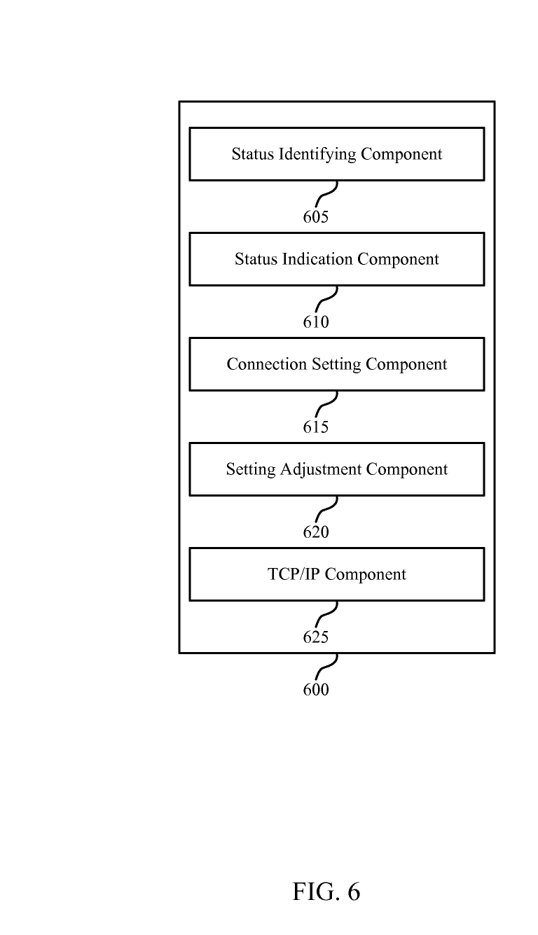

FIG. 6 shows a block diagram of a dynamic connection setting component 600 which may be an example of the corresponding component of wireless device 400 or wireless device 500 described with reference to FIGS. 4 and/or 5.

In one embodiment, the dynamic connection setting component 600 may include a status identifying component 605, a status indication component 610, a connection setting component 615, a setting adjustment component 620, and a TCP/IP component 625. Each of these components may communicate, directly or indirectly, with one another (e.g., via one or more buses).

The status identifying component 605 may identify an indication of status information of a UE. In some cases, the indication of status information is identified based at least in part by a software application executing on the UE. In some cases, the indication of status information is system status and usage information of the UE.

In one embodiment, the status indication component 610 may indicate that the status information should be transmitted from the UE to the network server when the indication of status information of the UE satisfies a predetermined threshold. In another embodiment, the status indication component 610 may indicate that the status information may be transmitted at predetermined time intervals.

The connection setting component 615 may receive, from a receiver of the UE, a recommended connection setting for the UE based at least in part on the indication of status information, and the recommended connection setting determined by the network server. The recommended connection setting may be received from a base station associated with the UE. In some cases, the recommended connection setting is based at least in part on one or more parameters associated with the UE.

The setting adjustment component 620 may receive an adjusted connection setting based at least in part on the recommended connection setting. In some embodiments, the adjusted connection setting may be based at least in part on available network resources. In other embodiments, the adjusted connection setting may be based at least in part on power and performance tradeoff parameters. In another embodiment, the adjusted connection setting may be based at least in part on a prioritization of available network resources. In one embodiment, the adjusted connection setting may be received from a base station associated with the UE. The TCP/IP component 625 may indicate that the indication of status information should be transmitted using a transmission control protocol/internet protocol (TCP/IP) connection.

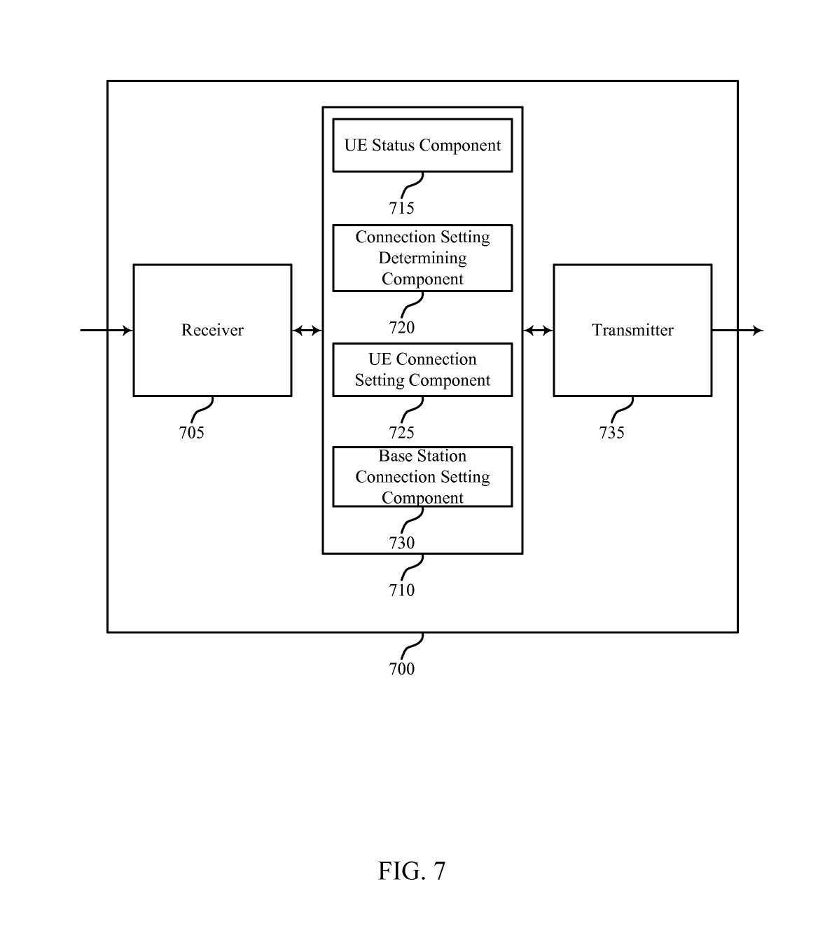

FIG. 7 shows a block diagram of a wireless device 700 that supports dynamic adjustment of connection settings based on per-UE system status and usage information in accordance with various aspects of the present disclosure. Wireless device 700 may be an example of aspects of a wireless device 400 or a network server 135 described with reference to FIGS. 1, 2A, 2B, 3 and/or 4. Wireless device 700 may include a receiver 705, a dynamic connection setting component 710 and a transmitter 735. Wireless device 700 may also include a processor. Each of these components may be in communication with each other.

The receiver 705 may receive information which may be passed on to other components of the device. The receiver 705 may also perform the functions described with reference to the receiver 405 of FIG. 4.

The dynamic connection setting component 710 may be an example of aspects of the dynamic connection setting component 410 described with reference to FIG. 4. In one embodiment, the dynamic connection setting component 710 may include a UE status component 715, a connection setting determining component 720, and a UE connection setting component 725.

The UE status component 715 may receive an indication of first status information for a first UE, and receive an indication of second status information for a second user equipment.

The connection setting determining component 720 may determine a recommended connection setting for the first UE based at least in part on the first status information. The connection setting determining component 720 may also determine a second recommended connection setting based at least in part on the second status information. In addition, the connection setting determining component 720 may determine the recommended connection setting based at least in part on one or more parameters associated with the first UE and/or the second UE.

The UE connection setting component 725 may indicate the determined recommended connection setting should be transmitted to a first base station associated with the first UE. The UE connection setting component 725 may also indicate that the second recommended connection setting should be transmitted to a second base station associated with a third UE.

The transmitter 735 may transmit signals received from other components of wireless device 700. In one embodiment, the transmitter 735 may be collocated with a receiver in a transceiver component. The transmitter 735 may utilize a single antenna or a plurality of antennas.

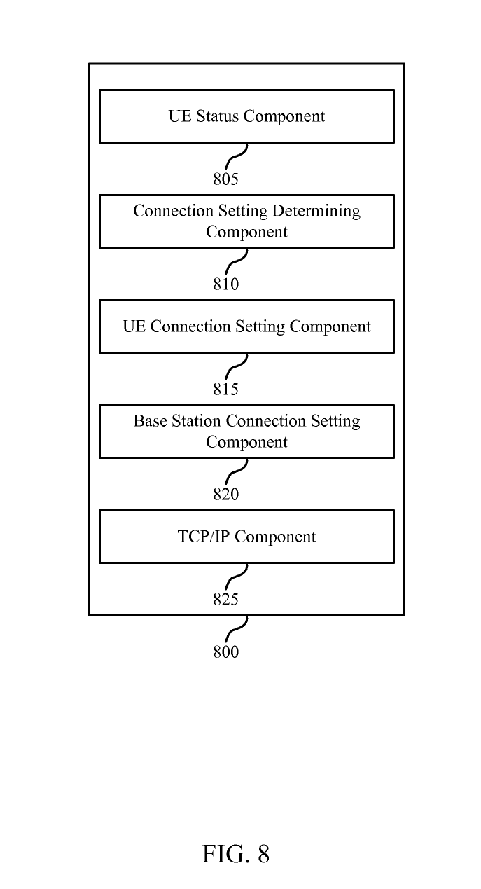

FIG. 8 shows a block diagram of a dynamic connection setting component 800 which may be an example of the corresponding component of wireless device 400 or wireless device 700. For example, dynamic connection setting component 800 may be an example of aspects of dynamic connection setting component 410 or dynamic connection setting component 710 described with reference to FIGS. 4 and/or 7.

The dynamic connection setting component 800 may include a UE status component 805, a connection setting determining component 810, a UE connection setting component 815, and a TCP/IP component 820. Each of these components may communicate, directly or indirectly, with one another (e.g., via one or more buses).

The UE status component 805 may receive an indication of first status information for a first UE, and an indication of second status information for a second UE.

The connection setting determining component 810 may determine a recommended connection setting for the first UE based at least in part on the first status information. The connection setting determining component 810 may also determine a second recommended connection setting based at least in part on the second status information. The connection setting determining component 810 may also determine the recommended connection setting based at least in part on one or more parameters associated with the user equipment.

The UE connection setting component 815 may provide the determined recommended connection setting to the transmitter 735 to be transmitted to a first base station associated with the first UE. The UE connection setting component 815 may also provide the second recommended connection setting to the transmitter 735 to be transmitted to a second base station associated with a third UE.

The TCP/IP component 820 may receive the indication of first status information using a transmission control protocol/internet protocol (TCP/IP) connection.

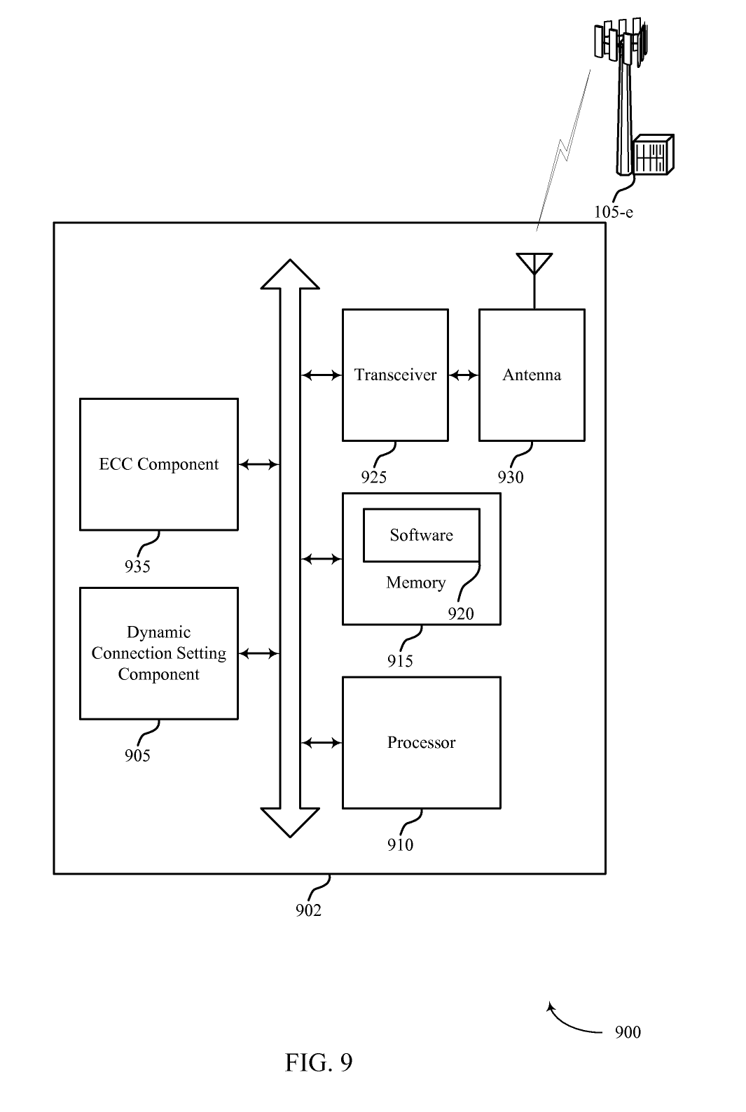

FIG. 9 shows a diagram of a system 900 including a device that supports dynamic adjustment of connection settings based on per-UE system status and usage information in accordance with various aspects of the present disclosure. For example, system 900 may include device 902, which may be an example of a UE 115 and/or a network server 135, and/or wireless device 400, wireless device 500, and/or wireless device 700 as described with reference to FIGS. 1, 2A, 2B, 3, 4, 5, 6, 7, and/or 8.

In one embodiment, device 902 may also include a dynamic connection setting component 905, a processor 910, a memory 915, a transceiver 925, an antenna 930 and an ECC component 935. Each of these components may communicate, directly or indirectly, with one another (e.g., via one or more buses). The dynamic connection setting component 905 may be an example of a dynamic connection setting component 410 as described with reference to FIG. 4. In one embodiment, the dynamic connection setting component 910 may identify an indication of status information of a UE. The dynamic connection setting component may transmit the indication of status information from the UE to a network server, and receive, from a base station associated with the UE, a recommended connection setting for the user equipment. The recommended connection setting may be determined by the network server and may be based at least in part on the indication of status information.

The processor 910 may include an intelligent hardware device, (e.g., a central processing unit (CPU), a microcontroller, an application specific integrated circuit (ASIC), etc.). The memory 915 may include random access memory (RAM) and read only memory (ROM). The memory 915 may store computer-readable, computer-executable software including instructions that, when executed, cause the processor to perform various functions described herein (e.g., dynamic adjustment of connection settings based on per-UE system status and usage information, etc.). In some embodiments, the software 920 may not be directly executable by the processor but enable a computer (e.g., when compiled and executed) to perform functions described herein.

The transceiver 925 may communicate bi-directionally, via one or more antennas, wired, or wireless links, with one or more networks, as described above. For example, the transceiver 925 may communicate bi-directionally with a base station 105-e and/or a UE 115 and/or a network server 135. The transceiver 925 may also include a modem to modulate the packets and provide the modulated packets to the antennas for transmission, and to demodulate packets received from the antennas. In some cases, the wireless device may include a single antenna 930. However, in some cases the device may have more than one antenna 930, which may be capable of concurrently transmitting or receiving multiple wireless transmissions.

The ECC component 935 may enable operations using enhanced component carrier (ECCs) such as communication using shared or unlicensed spectrum, using reduced transmission time intervals (TTIs) or subframe durations, or using a large number of component carriers (CCs).

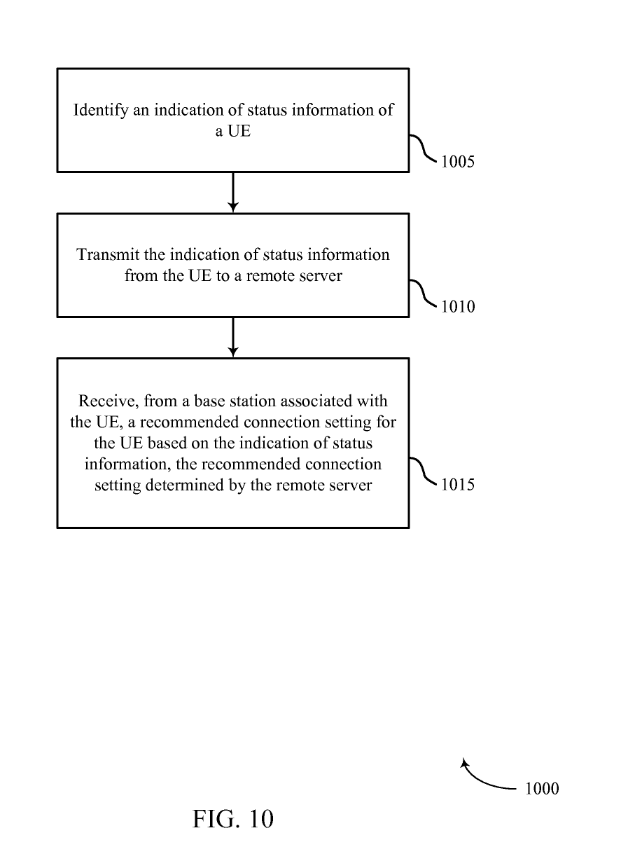

FIG. 10 shows a flowchart illustrating a method 1000 for dynamic adjustment of connection settings based on per-UE system status and usage information in accordance with various aspects of the present disclosure. The operations of method 1000 may be implemented by a UE 115 or its components as described with reference to FIGS. 1, 2A, 2B, 3, 4, 5, 6, 7, 8, and/or 9. For example, the operations of method 1000 may be performed by the dynamic connection setting component as described herein. In some examples, the UE 115 may execute a set of codes to control the functional elements of the device to perform the functions described below. Additionally or alternatively, the UE 115 may perform aspects the functions described below using special-purpose hardware.

At block 1005, the UE 115 may identify an indication of status information of a UE as described above with reference to FIGS. 2 and 3. In certain examples, the operations of block 1005 may be performed by the status identifying component 515 as described with reference to FIG. 5.

At block 1010, the UE 115 may transmit the indication of status information from the UE to a network server as described above with reference to FIGS. 2 and 3. In certain examples, the operations of block 1010 may be performed by the status indication component 520 as described with reference to FIG. 5.

At block 1015, the UE 115 may receive, from a base station associated with the UE, a recommended connection setting for the UE based on the indication of status information, the recommended connection setting determined by the network server as described above with reference to FIGS. 2 and 3. In certain examples, the operations of block 1015 may be performed by the connection setting component 525 as described with reference to FIG. 5.

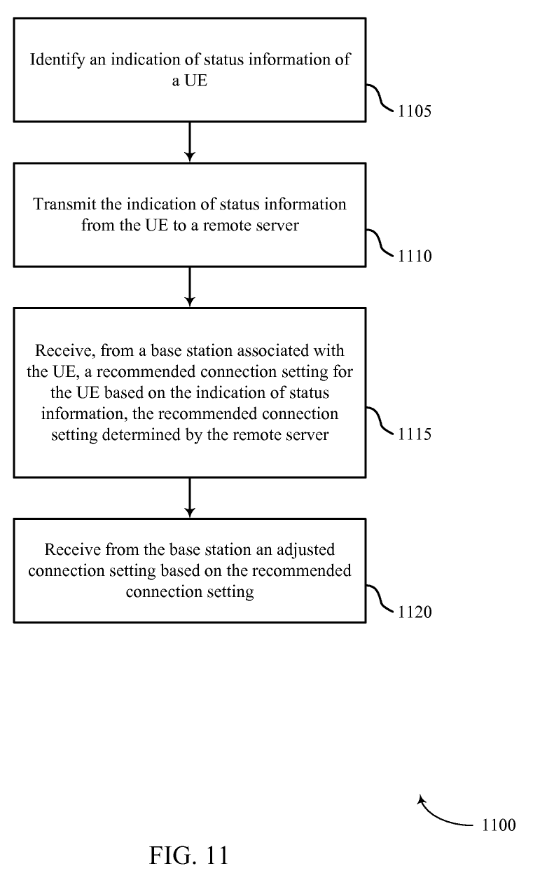

FIG. 11 shows a flowchart illustrating a method 1100 for dynamic adjustment of connection settings based on per-UE system status and usage information in accordance with various aspects of the present disclosure. The operations of method 1100 may be implemented by a UE 115 or its components as described with reference to FIGS. 1, 2A, 2B, 3, 4, 5, 6, 7, 8, and/or 9. For example, the operations of method 1100 may be performed by the dynamic connection setting component as described herein. In some examples, the UE 115 may execute a set of codes to control the functional elements of the device to perform the functions described below. Additionally or alternatively, the UE 115 may perform aspects the functions described below using special-purpose hardware.

At block 1105, the UE 115 may identify an indication of status information of a UE as described above with reference to FIGS. 2 and 3. In certain examples, the operations of block 1105 may be performed by the status identifying component 515 as described with reference to FIG. 5.

At block 1110, the UE 115 may transmit the indication of status information from the UE to a network server as described above with reference to FIGS. 2 and 3. In certain examples, the operations of block 1110 may be performed by the status indication component 520 as described with reference to FIG. 5.

At block 1115, the UE 115 may receive, from a base station associated with the UE, a recommended connection setting for the UE based on the indication of status information, the recommended connection setting determined by the network server 135 as described above with reference to FIGS. 2 and 3. In certain examples, the operations of block 1115 may be performed by the connection setting component 525 as described with reference to FIG. 5.

At block 1120, the UE 115 may receive from the base station an adjusted connection setting based on the recommended connection setting as described above with reference to FIGS. 2 and 3. In certain examples, the operations of block 1120 may be performed by the setting adjustment component 620 as described with reference to FIG. 6.

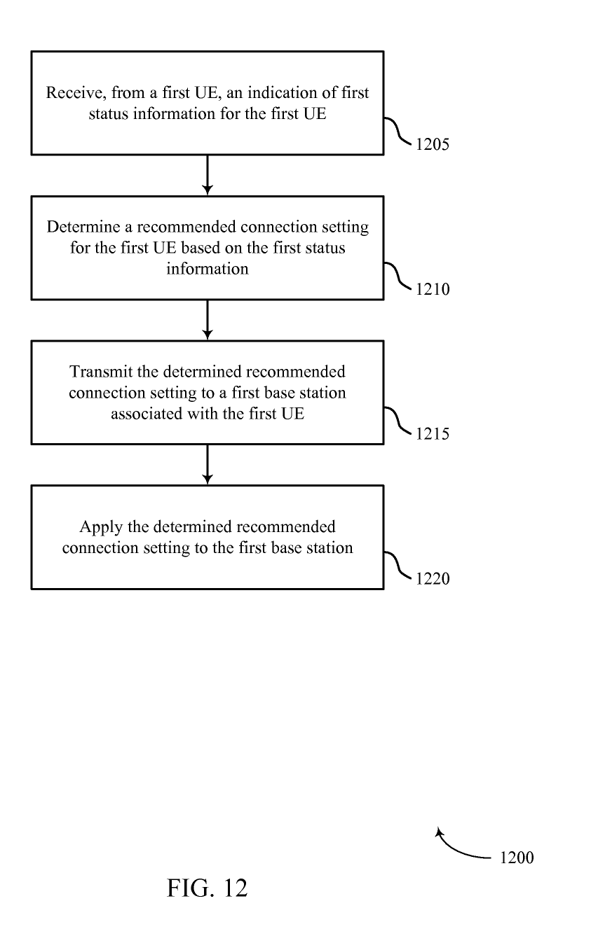

FIG. 12 shows a flowchart illustrating a method 1200 for dynamic adjustment of connection settings based on per-UE system status and usage information in accordance with various aspects of the present disclosure. The operations of method 1200 may be implemented by a network server 135 or its components as described with reference to FIGS. 1, 2A, 2B, 3, 4, 5, 6, 7, 8, and/or 9. For example, the operations of method 1200 may be performed by the dynamic connection setting component as described herein. In some examples, the network server 135 may execute a set of codes to control the functional elements of the device to perform the functions described below. Additionally or alternatively, the network server 135 may perform aspects the functions described below using special-purpose hardware.

At block 1205, the network server 135 may receive, from a first UE, an indication of first status information for the first UE as described above with reference to FIGS. 2 and 3. In certain examples, the operations of block 1205 may be performed by the UE status component 715 as described with reference to FIG. 7.

At block 1210, the network server 135 may determine a recommended connection setting for the first UE based on the first status information as described above with reference to FIGS. 2 and 3. In certain examples, the operations of block 1210 may be performed by the connection setting determining component 720 as described with reference to FIG. 7.

At block 1215, the network server 135 may transmit the determined recommended connection setting to a first base station associated with the first UE as described above with reference to FIGS. 2 and 3. In certain examples, the operations of block 1215 may be performed by the UE connection setting component 725 as described with reference to FIG. 7.

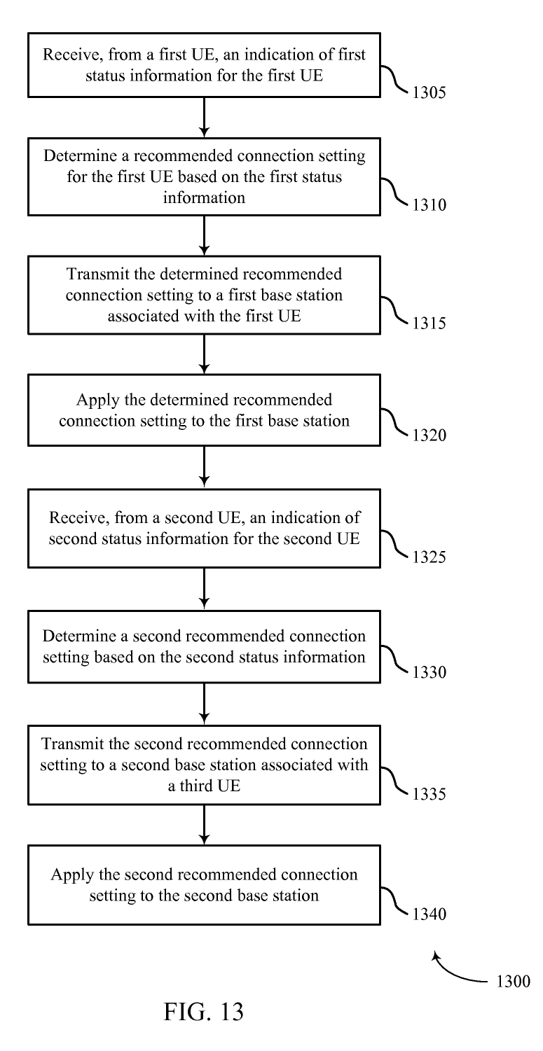

FIG. 13 shows a flowchart illustrating a method 1300 for dynamic adjustment of connection settings based on per-UE system status and usage information in accordance with various aspects of the present disclosure. The operations of method 1300 may be implemented by a network server 135 or its components as described with reference to FIGS. 1, 2A, 2B, 3, 4, 5, 6, 7, 8, and/or 9. For example, the operations of method 1300 may be performed by the dynamic connection setting component as described herein. In some examples, the network server 135 may execute a set of codes to control the functional elements of the device to perform the functions described below. Additionally or alternatively, the network server 135 may perform aspects the functions described below using special-purpose hardware.

At block 1305, the network server 135 may receive, from a first UE, an indication of first status information for the first UE as described above with reference to FIGS. 2 through 3. In certain examples, the operations of block 1305 may be performed by the UE status component 715 as described with reference to FIG. 7.

At block 1310, the network server 135 may determine a recommended connection setting for the first UE based on the first status information as described above with reference to FIGS. 2 through 3. In certain examples, the operations of block 1310 may be performed by the connection setting determining component 720 as described with reference to FIG. 7.

At block 1315, the network server 135 may transmit the determined recommended connection setting to a first base station associated with the first UE as described above with reference to FIGS. 2 through 3. In certain examples, the operations of block 1315 may be performed by the UE connection setting component 725 as described with reference to FIG. 7.

At block 1320, the network server 135 may receive, from a second UE, an indication of second status information for the second UE as described above with reference to FIGS. 2 through 3. In certain examples, the operations of block 1320 may be performed by the UE status component 715 as described with reference to FIG. 7.

At block 1325, the network server 135 may determine a second recommended connection setting based on the second status information as described above with reference to FIGS. 2 through 3. In certain examples, the operations of block 1325 may be performed by the connection setting determining component 720 as described with reference to FIG. 7.

At block 1330, the network server 135 may transmit the second recommended connection setting to a second base station associated with a third UE as described above with reference to FIGS. 2 through 3. In certain examples, the operations of block 1330 may be performed by the UE connection setting component 725 as described with reference to FIG. 7.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for dynamic adjustment of connection settings based on per-UE system status and usage information.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical (PHY) locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium; for example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11 (wireless fidelity (Wi-Fi)), IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a Node B, eNode B (eNB), Home Node B (HNB), a Home eNode B (HeNB), or some other suitable terminology. The geographic coverage area for a base station may be divided into sectors making up only a portion of the coverage area. The wireless communications system or systems described herein may include base station of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 FIG. 1 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bi-directional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

Thus, aspects of the disclosure may provide for dynamic adjustment of connection settings based on per-UE system status and usage information. It should be noted that these methods describe possible implementations, and that the operations and the steps may be rearranged or otherwise modified such that other implementations are possible. In some examples, aspects from two or more of the methods may be combined.

The various illustrative blocks and components described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
identifying an indication of status information of a user equipment (UE);
transmitting the indication of status information from the UE to a remote server; and
receiving, from a base station associated with the UE, a recommended connection setting for the UE based at least in part on the indication of status information, the recommended connection setting determined by the remote server.

2. The method of claim 1, wherein the indication of status information is system status and usage information of the UE.

3. The method of claim 1, further comprising:
transmitting the indication of status information when a system status of the UE satisfies a predetermined threshold.

4. The method of claim 1, further comprising:
transmitting the indication of status information at predetermined time intervals.

5. The method of claim 1, further comprising:
transmitting the indication of status information using a transmission control protocol/internet protocol (TCP/IP) connection.

6. The method of claim 1, wherein the indication of status information is identified based at least in part by a software application executing on the UE.

7. The method of claim 1, further comprising:
receiving from the base station an adjusted connection setting based at least in part on the recommended connection setting.

8. The method of claim 7, wherein the adjusted connection setting is based at least in part on available network resources.

9. The method of claim 8, wherein the adjusted connection setting is based at least in part on power and performance tradeoff parameters.

10. The method of claim 8, wherein the adjusted connection setting is based at least in part on a prioritization of available network resources.

11. The method of claim 1, wherein the recommended connection setting is based at least in part on one or more parameters associated with the UE.

12. A method of wireless communication comprising:
receiving, from a first UE, an indication of first status information for the first UE;
determining a recommended connection setting for the first UE based at least in part on the first status information; and
transmitting the determined recommended connection setting to a first base station associated with the first UE.

13. The method of claim 12, further comprising:
receiving, from a second UE, an indication of second status information for the second UE;
determining a second recommended connection setting based at least in part on the second status information; and
transmitting the second recommended connection setting to a second base station associated with a third UE.

14. The method of claim 12, further comprising:
determining the recommended connection setting based at least in part on one or more parameters associated with the UE.

15. The method of claim 12, further comprising:
receiving the indication of first status information using a transmission control protocol/internet protocol (TCP/IP) connection.

16. An apparatus for wireless communication comprising:
means for identifying an indication of status information of a user equipment (UE);
means for transmitting the indication of status information from the UE to a remote server; and
means for receiving, from a base station associated with the UE, a recommended connection setting for the UE based at least in part on the indication of status information, the recommended connection setting determined by the remote server.

17. The apparatus of claim 16, wherein the indication of status information is system status and usage information of the UE.

18. The apparatus of claim 16, further comprising:
means for transmitting the indication of status information when a system status of the UE satisfies a predetermined threshold.

19. The apparatus of claim 16, further comprising:
means for transmitting the indication of status information at predetermined time intervals.

20. The apparatus of claim 16, further comprising:
means for transmitting the indication of status information using a transmission control protocol/internet protocol (TCP/IP) connection.

21. The apparatus of claim 16, wherein the indication of status information is identified based at least in part by a software application executing on the UE.

22. The apparatus of claim 16, further comprising:
means for receiving from the base station an adjusted connection setting based at least in part on the recommended connection setting.

23. The apparatus of claim 22, wherein the adjusted connection setting is based at least in part on available network resources.

24. The apparatus of claim 23, wherein the adjusted connection setting is based at least in part on power and performance tradeoff parameters.

25. The apparatus of claim 23, wherein the adjusted connection setting is based at least in part on a prioritization of available network resources.

26. The apparatus of claim 16, wherein the recommended connection setting is based at least in part on one or more parameters associated with the UE.

27. An apparatus for wireless communication comprising:
means for receiving, from a first UE, an indication of first status information for the first UE;
means for determining a recommended connection setting for the first UE based at least in part on the first status information; and
means for transmitting the determined recommended connection setting to a first base station associated with the first UE.

28. The apparatus of claim 27, further comprising:
means for receiving, from a second UE, an indication of second status information for the second UE;
means for determining a second recommended connection setting based at least in part on the second status information; and
means for transmitting the second recommended connection setting to a second base station associated with a third UE.

29. The apparatus of claim 27, further comprising:
means for determining the recommended connection setting based at least in part on one or more parameters associated with the UE.

30. The apparatus of claim 27, further comprising:
means for receiving the indication of first status information using a transmission control protocol/internet protocol (TCP/IP) connection.
